(19) United States
(12) Patent Application Publication
(10) Pub. No.: US 2023/0261188 A1
(43) Pub. Date: Aug. 17, 2023

(54) BATTERY PRODUCTION WORKFLOW OPTIMIZATION

(71) Applicant: Mitra Future Technologies, Inc., Mountain View, CA (US)

(72) Inventors: Xiaofei YE, Mountain View, CA (US); Chirranjeevi Balaji GOPAL, San Francisco, CA (US); William CHUEH, Menlo Park, CA (US); Prateek MEHTA, San Francisco, CA (US)

(73) Assignee: Mitra Future Technologies, Inc., Mountain View, CA (US)

(21) Appl. No.: 18/110,311

(22) Filed: Feb. 15, 2023

Related U.S. Application Data
(60) Provisional application No. 63/310,392, filed on Feb. 15, 2022.
(60) Provisional application No. 63/445,712, filed on Feb. 14, 2023.

(51) Int. Cl. H01M 4/58; G06N 3/084; C01B 25/45

(52) U.S. Cl. CPC H01M 4/5825; G06N 3/084; C01B 25/45; H01M 2004/028

(57) ABSTRACT

A method includes accessing one or more models of battery cathode synthesis, battery cell prototyping, battery cell testing, or a combination thereof. The method also includes applying the one or more models for controlling one or more steps in a battery production workflow.

### CROSS-REFERENCE TO RELATED PATENT APPLICATIONS

This patent application claims the benefit under 35 U.S.C. § 119(e) of U.S. Patent Application Ser. No. 63/445,712, entitled “BATTERY PRODUCTION WORKFLOW OPTIMIZATION,” filed on Feb. 14, 2023, and U.S. Patent Application Ser. No. 63/310,392, entitled “BATTERY PRODUCTION WORKFLOW OPTIMIZATION,” filed on Feb. 15, 2022, each of the foregoing applications is incorporated herein by reference in its entirety.

### FIELD

The present invention relates to systems, methods, and computer-readable media for facilitating a battery production workflow through one or more models.

### BACKGROUND

Batteries are an essential part of many devices from power tools, to home power systems, to electric and hybrid cars, among many other applications. Indeed batteries are a key technological pillar upon which many other technologies are built. Given the wide range of applications in which batteries are used, there is a similarly wide range of design requirements to develop battery cathode materials suitable for their applications. Unfortunately, the development of a new battery can be a time-consuming process, and expensive too.

Machine learning has shown promising results in a variety of applications. In the field of materials science, machine learning is used to develop new materials, optimize existing materials, and predict the properties of materials. One area of interest in the field of materials science is the synthesis of cathode materials for lithium-ion batteries. Lithium-ion batteries are used in many applications, including portable electronics, electric vehicles, and energy storage systems. The performance of these batteries is partially dependent on the cathode material used.

Lithium iron phosphate (LFP), nickel-cobalt-aluminum oxide (NCA), and nickel-cobalt-manganese oxide (NMC) are commonly used cathode materials in lithium-ion batteries. Synthesis of these cathode materials is a complex process involving various precursors and synthesis processing conditions. Modifying the precursors and synthesis processing conditions allow for the optimization of the properties of cathode materials. However, when optimizing the properties of cathode materials, it is challenging, expensive, and time-consuming to select precursors and the ratios of precursors and to control synthesis processing conditions.

It is desirable to have cathode materials with improved properties at reduced costs. However, development cycles for cathode materials with improved properties are very long. Therefore, there remains a need to develop methods to accelerate cathode material synthesis and battery cell production.

### BRIEF SUMMARY

In one aspect, a method is provided for reducing the time and cost of developing a cathode powder meeting custom performance parameters defining performance attributes for a battery. The method includes receiving the customer performance parameters defining the performance attributes for the battery and converting the customer performance parameters to material parameters for the cathode of the battery. The method also includes providing the material parameters for the battery into a battery composition prediction model. The method further includes receiving candidate compound formulations with synthesis processing parameters for the synthesis of the compound formulations from the battery composition prediction model.

In some variations, the method may also include performing Bayesian optimization based on the material parameters for the cathode to identify the candidate compound formulations and the processing parameters.

In some variations, the method may also include selecting a subset of the candidate compound formulations with the processing parameters to be synthesized, where a number of potential candidate compound formulations for synthesis and experimentation are reduced.

In some variations, the selected subset of the candidate compound formulations with the processing parameters includes 50% of the candidate compound formulations with the processing parameters having the highest confidence value for meeting the material parameters of the cathode of the battery.

In some variations, the selected subset of the candidate compound formulations with the processing parameters includes 30% of the candidate compound formulations with the processing parameters having the highest confidence value for meeting the material parameters of the cathode of the battery.

In some variations, the selected subset of the candidate compound formulations with the processing parameters includes 20% of the candidate compound formulations with the processing parameters having the highest confidence value for meeting the material parameters of the cathode of the battery.

In some variations, the method may also include generating respective cathode powders from the selected subset of the candidate compound formulations using the processing parameters from the battery composition prediction model.

In some variations, the method may also include performing material characterizations on the candidate cathode powders.

In some variations, the method may also include selecting a first subset of the respective candidate cathode powders based on the material characterizations for use in building respective batteries from the first subset of the respective candidate cathode powders.

In some variations, the material characterizations of the cathode powders are performed by using one or more X-ray diffraction analyses (XRD), scanning electron microscopy (SEM), or Energy-dispersive X-ray spectroscopy (EDS).

In some variations, the material characterizations of the cathode powders include one or more elemental compositions, phase purity, crystallinity, particle size, surface area, or tap density.

In some variations, the method may also include determining, based on results from the material characterizations of the cathode powders, whether to build candidate coin cells from the first subset of the plurality of candidate cathode powder or determining, based on results from testing the candidate coin cells, whether to build candidate pouch cells from the first subset of the plurality of candidate cathode powders for an evaluation of the candidate powders under the plurality of environmental conditions.

In some variations, the method may also include monitoring performance attributes of the respective test batteries made from the first subset of the respective candidate cathode powders over a first interval;

In some variations, the method may also include providing data derived from the monitoring of the performance attributes for the respective test batteries made from the first subset of the respective candidate cathode powders over the first interval into a battery performance model. In some variations, the method may also include receiving predicted performance attributes for the test batteries over a second interval that is longer than the first interval.

In some variations, the performance attributes of the battery include one or more of internal resistance, voltage, capacity, or cycle life.

In some variations, the method may also include providing the material characterizations on the respective candidate cathode powders as feedback to the battery composition prediction model, whereby the battery composition prediction model is refined based on the feedback.

In some variations, a compound may include lithium iron phosphate (LFP), lithium manganese iron phosphate (LMFP), or other polyanion cathodes for Li-ion batteries, wherein the compound is optimized by the method for reducing the time and cost of developing a cathode powder meeting custom performance parameters defining performance attributes for the battery.

In some variations, a particle may include the compound including lithium iron phosphate (LFP), lithium manganese iron phosphate (LMFP), or other polyanion cathodes for Li-ion batteries.

In some variations, a powder includes a plurality of particles including the compound including lithium iron phosphate (LFP), lithium manganese iron phosphate (LMFP), or other polyanion cathodes for Li-ion batteries.

In some variations, a cathode may include a cathode current collector and a cathode active material disposed over the cathode current collector, the cathode active material including the compound including lithium iron phosphate (LFP), lithium manganese iron phosphate (LMFP), or other polyanion cathodes for Li-ion batteries, the particle including the compound, or the powder including a plurality of the particles.

In some variations, a battery cell may include an anode including an anode current collector, and an anode active material disposed over the anode current collector. The battery cell may also include the cathode.

Additional embodiments and features are set forth in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 is an illustrative example of a deep learning neural network according to some embodiments of the disclosure;

FIG. 2 illustrates an example of a processor-based computing system according to some embodiments of the disclosure;

FIG. 3 is a workflow illustrating the steps for cathode synthesis and qualification at both powder and cell levels according to some embodiments of the disclosure;

FIG. 4 illustrates a machine learning-assisted and scale-up-oriented approach according to some embodiments of the disclosure;

FIG. 5 illustrates an approach for developing LFP with improved volumetric energy density (VED), gravimetric energy density (GED), and low-temperature handling according to some embodiments of the disclosure;

FIG. 6 is a flow chart illustrating steps for reducing the time and cost of developing a cathode powder meeting custom performance parameters defining performance attributes for a battery according to some embodiments of the disclosure;

FIG. 7A illustrates steps for powder synthesis according to some embodiments of the disclosure;

FIG. 7B is a continuation of FIG. 7A and illustrates steps for material characterizations of powder and decision-making for coin cell building according to some embodiments of the disclosure;

FIG. 8 illustrates steps for coin cell testing and decision-making for pouch cell building according to some embodiments of the disclosure;

FIG. 9 illustrates a top-down view of a battery cell according to some embodiments of the disclosure;

FIG. 10 illustrates a side view of a set of layers for a battery cell according to some embodiments of the disclosure;

FIG. 11 illustrates demonstrated success in scaleup acceleration according to some embodiments of the disclosure;

FIG. 12 illustrates a hierarchical material screening workflow for fast timelines and resource-efficient selections of cathode designs according to some embodiments of the disclosure;

FIG. 13A illustrates a workflow in week 1 for a batch size of about 1 g to 10 g according to some embodiments of the disclosure;

FIG. 13B illustrates a workflow in week 1 for a batch size of about 10 g to 50 g according to some embodiments of the disclosure;

FIG. 13C is a continuation of the workflow of FIG. 13 B for the batch size of 10 g to 50 g from week 2 to week 7 according to some embodiments of the disclosure;

FIG. 13D illustrates a workflow from week 1 to week 2 for a batch size of 50 g to 500 g according to some embodiments of the disclosure;

FIG. 13E is a continuation of the workflow of FIG. 13D for the batch size of 50 g to 500 g from week 3 to week 10 according to some embodiments of the disclosure;

FIG. 14 illustrates finding optimal process parameters for the synthesis of a cathode powder weighing aspects of phase impurity versus the ratio of carbon (C) to iron (Fe) using active learning from a battery composition prediction model according to some embodiments of the disclosure;

FIG. 15 illustrates finding optimal process parameters for the synthesis of a cathode powder weighing aspects of phase impurity and calcination temperature using active learning from a battery composition prediction model according to some embodiments of the disclosure;

FIG. 16 illustrates capacity versus particle size according to some embodiments of the disclosure; and

FIG. 17 illustrates correlations between observed discharge capacities and predicted discharge capacities according to some embodiments of the disclosure.

### DETAILED DESCRIPTIONS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details to provide a more thorough understanding of the subject of technology. However, it will be clear and apparent that the subject technology is not limited to the specific details set forth herein and may be practiced without these details. In some instances, structures and components are shown in block diagram form to avoid obscuring the concepts of the subject technology.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be references to the same embodiment or any embodiment, and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained utilizing the instruments and combinations particularly pointed out in the appended claims. These and other features of the disclosure will become more fully apparent from the following description and appended claims or can be learned by the practice of the principles set forth herein.

i. Overview

The conventional linear workflow for designing and synthesizing a cathode powder or a battery has several limitations. Firstly, the optimization process is sequential, meaning the order of variables is crucial. Secondly, the interactions between variables are often overlooked for the sake of simplicity. Additionally, the conventional linear workflow relies heavily on expert intuition, which becomes impractical in high-dimensional spaces. The optimization only considers one factor at a time and is limited to single-objective optimization. Lastly, the conventional linear workflow utilizes a static design of experiments, which can be an inefficient use of resources.

The present technology addresses the needs in the art of accelerating powder synthesis optimization and battery cell production. The present technology uses the latest advances in machine learning (ML) and informatics-enabled instrumentation in support of a deep understanding of the chemistry of materials to perform adaptive experimentation. The present technology also uses a hierarchical screening approach to efficiently explore the design space and to identify top candidates for production faster than the conventional “linear” approach. The hierarchical material screening enables down-selection to the most promising candidates while reducing the overall number of samples and thus reducing the duration of each learning cycle from about three weeks to about four days or less. The metrology analysis tools, such as XRD and SEM, enable the automated acquisition of data and automated structure and phase characterization.

The present technology also combines physically grounded workflows with ML and active learning strategies and enables faster decision-making. The present technology also combines diverse data streams, diverse fidelity, simulations, and experimental data.

The present technology accesses one or more models of battery cathode synthesis, battery cell prototyping, battery cell testing, or a combination and applies the one or more models for controlling one or more steps in a battery production workflow.

The present technology is better than the conventional “linear” approach for several reasons. First, the key bottleneck of the conventional “linear” approach is that there is no substitute for the actual material synthesis of many candidates, but the present technology can utilize algorithms to reduce the number of candidates for actual material synthesis. Second, the present technology provides a solution that automatically runs essential experiments and can extrapolate the results of those experiments to speed up the experimentation process. Also, the present technology considers interactions between variables and trade-offs in selecting viable candidates as opposed to optimizing a single variable at a time.

The present technology uses machine learning models to accelerate design, build, and testing cycles. For example, the present technology uses Bayesian Active Learning for synthesis optimization, which reduces iterations using ML-guided optimization for making cathode powders. The present technology also uses cell life cycle forecasting with early prediction models. The present technology also uses automated processing and analysis of metrology data and eliminates tedious manual data processing and allows rich feature extraction from complex data variations.

ii. Machine Learning Assisted Synthesis and Optimization of Cathodes

Bayesian active learning guided experimental design balances exploration and exploitation of design spaces under uncertainty. The Bayesian active learning-guided experimental design uses an algorithm to suggest process parameters and compound formulations with a greater likelihood of success when given a set of metric targets. For example, the metric targets may include the target cell properties of a battery cell, such as internal resistance, voltage, capacity, and cycle life, among others. The metric targets are converted based on customer requirements. When customers provide requirements, such as specific energy, specific power, performance, life span, safety, and cost, developments of a target battery cell including cathode powders are accelerated by using an optimization approach. An example of this approach is presented in vii. Example hierarchical material screening workflow.

The present technology utilizes an optimization to learn design rules, which are transferable from lithium iron phosphate (LFP) to lithium manganese iron phosphate (LMFP), from LFP to other polyanion cathodes for Li-ion batteries, or from LFP cathode powders to LMFP cathode powders to other polyanion cathode powders, among others.

Bayesian active learning guided experimental design builds physics-based constraints into models to improve the accuracy of the predictions and reduce the number of experiments needed. In addition, the physics-based constraints help ensure that the models are consistent with known laws of physics, and the models can also provide insight into the underlying processes that govern the system. The physics-based constraints allow the model to capture the underlying physics of the system and incorporate prior knowledge. Bayesian active learning can be used to predict the outputs for different input combinations and to identify the input combinations that would be most informative if measured. This information is then used to guide the selection of subsequent experiments.

The benchmarked lithium iron phosphate (LFP) and lithium manganese iron phosphate (LMFP) developments demonstrated about 50% to 70% speedup compared to traditional experimentations without Bayesian active learning guidance. Examples of the Bayesian active learning guided experimental design are provided in viii. Example Results from Bayesian Active Learning and Validation Experiments.

Machine learning algorithms can be trained on data from previous experiments to predict the properties of cathode materials synthesized under various conditions to optimize the synthesis conditions and improve the properties of the materials.

A method is provided for reducing the time and cost of developing a cathode powder meeting custom performance parameters defining performance attributes for a battery. When the customer performance parameters defining the performance attributes for the battery are received from a client, one of the persons skilled in the art may convert the customer performance parameters to material parameters for the cathode of the battery and may provide the material parameters for the battery into a battery composition prediction model. One of the persons skilled in the art may receive candidate compound formulations with synthesis processing parameters for the synthesis of the compound formulations from the battery composition prediction model.

In some variations, a processor may perform Bayesian optimization based on the material parameters for the cathode to identify the candidate compound formulations and the processing parameters. The processor may also select a subset of the candidate compound formulations with the processing parameters to be synthesized, whereby the number of potential candidate formulations for synthesis and experimentation is reduced.

In some variations, the selected subset of the candidate compound formulations with the processing parameters includes 50% of the candidate compound formulations with the processing parameters having the highest confidence value for meeting the material parameters of the cathode of the battery.

In some variations, the selected subset of the candidate compound formulations with the processing parameters includes 30% of the candidate compound formulations with the processing parameters having the highest confidence value for meeting the material parameters of the cathode of the battery.

In some variations, the selected subset of the candidate compound formulations with the processing parameters includes 20% of the candidate compound formulations with the processing parameters having the highest confidence value for meeting the material parameters of the cathode of the battery.

In some variations, one of the persons skilled in the art may generate respective cathode powders from the selected subset of the candidate compound formulations using the processing parameters from the battery composition prediction model. One of the persons skilled in the art may perform material characterizations on the candidate cathode powders.

In some variations, one of the persons skilled in the art may analyze and select a first subset of the respective candidate cathode powders based on the material characterizations for use in building respective batteries from the first subset of the respective candidate cathode powders.

In some variations, the material characterizations of the cathode powders are performed by using one or more X-ray diffraction analyses (XRD), scanning electron microscopy (SEM), or Energy-dispersive X-ray spectroscopy (EDS).

In some variations, the material characterizations of the cathode powders comprise one or more elemental compositions, phase purity, crystallinity, particle size, surface area, or tap density.

In some variations, one of the persons skilled in the art may determine, based on results from the material characterizations of the cathode powders, whether to build candidate coin cells from the first subset of the plurality of candidate cathode powders or determine, based on results from testing the candidate coin cells, whether to build candidate pouch cells from the first subset of the plurality of candidate cathode powders for an evaluation of the candidate powders under the plurality of environmental conditions.

In some variations, one of the persons skilled in the art or a processor may monitor the performance attributes of the respective test batteries made from the first subset of the respective candidate cathode powders over a first interval and provide data derived from the monitoring of the performance attributes for the respective test batteries made from the first subset of the respective candidate cathode powders over the first interval into a battery performance model and receive predicted performance attributes for the test batteries over a second interval that is longer than the first interval. The performance attributes of the battery include one or more internal resistance, voltage, capacity, or cycle life.

In some variations, one of the persons skilled in the art may provide the material characterizations on the respective candidate cathode powders as feedback to the battery composition prediction model, whereby the battery composition prediction model is refined based on the feedback.

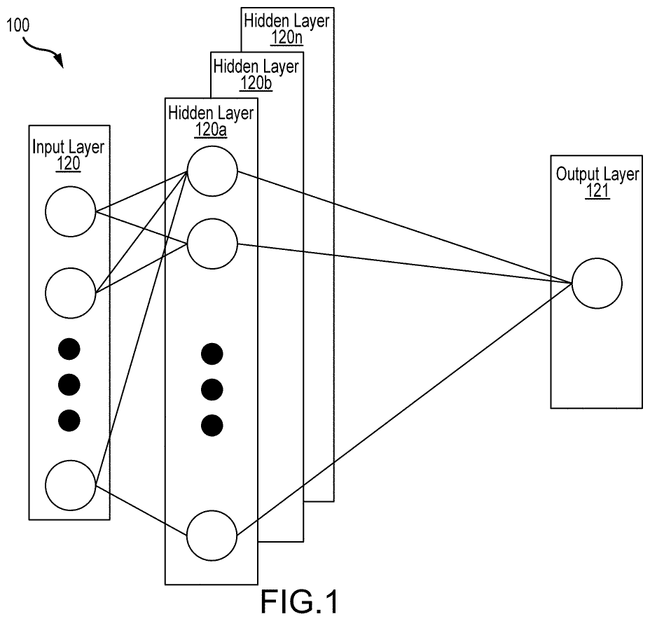

The disclosure now turns to a further discussion of models that can be used through the environments and techniques described herein. Specifically, FIG. 1 is an illustrative example of a deep learning neural network 100. An input layer 120 can be configured to receive input data. The neural network 100 includes multiple hidden layers 122a, 122b, through 122n. The hidden layers 122a, 122b, through 122n include “n” number of hidden layers, where “n” is an integer greater than or equal to one. The number of hidden layers can be made to include as many layers as needed for the given application. The neural network 100 further includes an output layer 121 that provides an output resulting from the processing performed by the hidden layers 122a, 122b, through 122n.

The neural network 100 is a multi-layer neural network of interconnected nodes. Each node can represent a piece of information. Information associated with the nodes is shared among the different layers and each layer retains information as information is processed. In some cases, the neural network 100 can include a feed-forward network, in which case there are no feedback connections where outputs of the network are fed back into itself. In some cases, the neural network 100 can include a recurrent neural network, which can have loops that allow information to be carried across nodes while reading in input.

Information can be exchanged between nodes through node-to-node interconnections between the various layers. Nodes of the input layer 120 can activate a set of nodes in the first hidden layer 122a. For example, as shown, each of the input nodes of the input layer 120 is connected to each of the nodes of the first hidden layer 122a. The nodes of the first hidden layer 122a can transform the information of each input node by applying activation functions to the input node information. The information derived from the transformation can then be passed to and can activate the nodes of the next hidden layer 122b, which can perform their own designated functions. Example functions include convolutional, up-sampling, data transformation, and/or any other suitable functions. The output of the hidden layer 122b can then activate nodes of the next hidden layer, and so on. The output of the last hidden layer 122n can activate one or more nodes of the output layer 121, at which output is provided. In some cases, while nodes in the neural network 100 are shown as having multiple output lines, a node can have a single output, and all lines shown as being output from a node represent the same output value.

In some cases, each node or interconnection between nodes can have a weight that is a set of parameters derived from the training of the neural network 100. Once the neural network 100 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 100 to be adaptive to inputs and able to learn as more and more data is processed.

The neural network 100 can be pre-trained to process the features from the data in the input layer 120 using the different hidden layers 122a, 122b, through 122n to provide the output through the output layer 121.

In some cases, the neural network 100 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training data until the neural network 100 is trained well enough so that the weights of the layers are accurately tuned.

As noted above, for a first training iteration for the neural network 100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 100 is unable to determine low-level features and thus cannot make an accurate determination of what the classification of the object might be. A loss function can be used to analyze errors in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The goal of training is to minimize the amount of loss so that the predicted output is the same as the training label. The neural network 100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i−η dL/dW, where w denotes a weight, wi denotes the initial weight, and η denotes a learning rate. The learning rate can be set to any suitable value, with a high learning rate including larger weight updates and a lower value indicating smaller weight updates.

The neural network 100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 100 can include any other deep network other than a CNN, such as an autoencoder, deep belief nets (DBNs), a Recurrent Neural Networks (RNNs), among others.

As understood by those of skill in the art, machine-learning-based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; generative adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

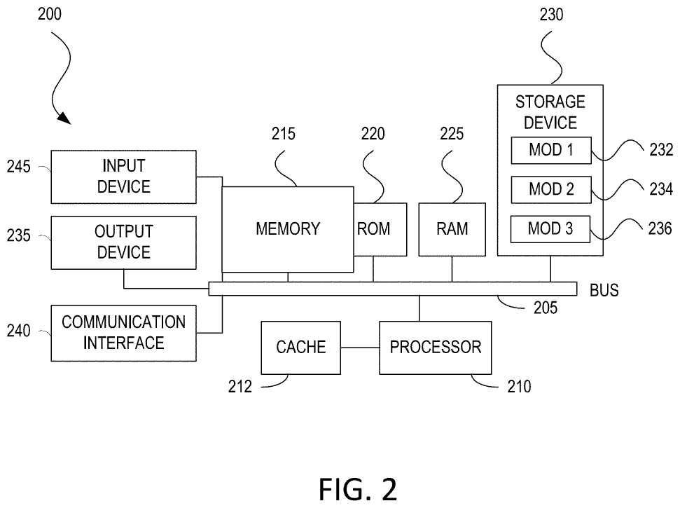

The disclosure now turns to FIG. 2 which illustrates an example of a processor-based computing system 200 wherein the components of the system are in electrical communication with each other using a bus 205. The computing system 200 can include a processing unit (CPU or processor) 210 and a system bus 205 that may couple various system components including the system memory 215, such as read-only memory (ROM) 220 and random-access memory (RAM) 225, to the processor 210. The computing system 200 can include a cache 212 of high-speed memory connected directly with, close to, or integrated as part of the processor 210. The computing system 200 can copy data from the memory 215, ROM 220, RAM 225, and/or storage device 230 to the cache 212 for quick access by the processor 210. In this way, cache 212 can provide a performance boost that avoids processor delays while waiting for data. These and other modules can control the processor 210 to perform various actions. Other system memory 215 may be available for use as well. Memory 215 can include multiple different types of memory with different performance characteristics. The processor 210 can include any general-purpose processor and a hardware module or software module, such as module 1 232, module 2 234, and module 3 236 stored in the storage device 230, configured to control the processor 210 as well as a special-purpose processor where software instructions are incorporated into the actual processor design. The processor 210 may essentially be a completely self-contained computing system, containing multiple cores or processors, a bus, a memory controller, a cache, etc. A multi-core processor may be symmetric or asymmetric.

To enable user interaction with the computing system 200, an input device 245 can represent any number of input mechanisms, such as a microphone for speech, a touch-protected screen for gesture or graphical input, a keyboard, mouse, motion input, speech, and so forth. An output device 235 can also be one or more of several output mechanisms known to those of skill in the art. In some instances, multimodal systems can enable a user to provide multiple types of input to communicate with the computing system 200. The communications interface 240 can govern and manage the user input and system output. There may be no restriction on operating on any particular hardware arrangement and therefore the basic features here may easily be substituted for improved hardware or firmware arrangements as they are developed.

The storage device 230 can be a non-volatile memory and can be a hard disk or other types of computer-readable media which can store data that are accessible by a computer, such as magnetic cassettes, flash memory cards, solid state memory devices, digital versatile disks, cartridges, random access memory, read-only memory, and hybrids thereof.

As discussed above, the storage device 230 can include the software modules 232, 234, and 236 for controlling the processor 210. Other hardware or software modules are contemplated. The storage device 230 can be connected to the system bus 205. In some embodiments, a hardware module that performs a particular function can include a software component stored in a computer-readable medium in connection with the necessary hardware components, such as the processor 210, bus 205, output device 235, and so forth, to carry out the function. For clarity of explanation, in some instances, the present technology may be presented as including individual functional blocks including functional blocks including devices, device components, steps or routines in a method embodied in software, or combinations of hardware and software.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special-purpose computer, or special-purpose processing device to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take any of a variety of form factors. Typical examples of such form factors include laptops, smartphones, small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

iii. Overall Workflow for Cell Development

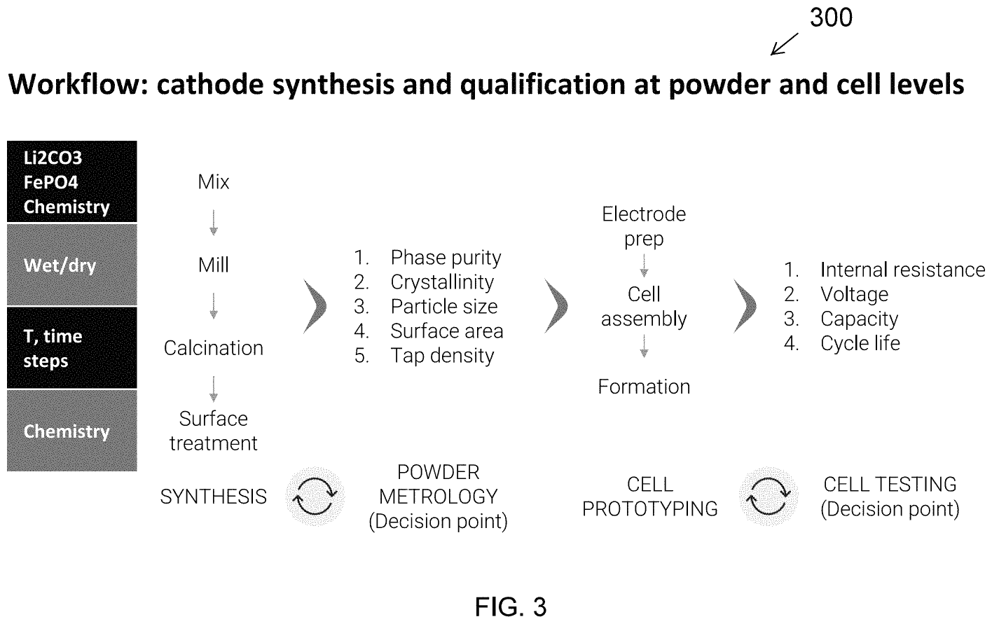

FIG. 3 is a workflow illustrating the steps for cathode synthesis and qualification at powder and cell levels according to an embodiment of the disclosure. As an example, workflow 300 is provided for forming a battery cell. Workflow or process 300 includes (1) synthesis, (2) powder metrology, (3) cell prototyping, and (4) cell testing.

The synthesis forms a cathode powder. As shown in FIG. 3, the synthesis includes mixing precursors, which relates to Li₂CO₃ and FePO₄ chemistry. The synthesis also includes milling under wet or dry conditions. The synthesis also includes calcination under various temperatures and times. The synthesis further includes surface treatment, which also relates to chemistry.

The powder metrology includes performing material characterizations and analyses at powder levels to determine if a cathode powder is suitable for the next step, i.e., cell prototyping or building a battery cell using the cathode powder. The material characterizations and analyses of the cathode powder are performed to determine one or more phase purity, crystallinity, particle size, the surface area of a cathode particle, and tap density, among others. In some embodiments, the powder metrology can be performed automatically and the results of the powder metrology can be fed back into a machine learning model used to identify the precursor materials and process parameters for making the powder.

The phase purity, crystallinity, particle size, the surface area of the cathode particle can be determined by material analytical tools, including X-ray diffraction analyses (XRD), scanning electron microscopy (SEM), energy-dispersive X-ray spectroscopy (EDS), among others.

The tap density of a cathode powder is determined after the defined tapping steps of the powder bed. Tap density considers pores and voids between particles, which are not based on a loose powder bed but a bed after a defined number of tapping steps. The tap density is an important material property for cathode powder. The tap density is different from the bulk density of a powder, which can be determined if a powder is loosely poured into a measuring cylinder. The bulk density considers the pores and voids of a loose powder bed.

Workflow 300 also includes cell prototyping, such as building a battery cell. Specifically, cell prototyping includes electrode preparation, cell assembly, and the formation of a battery cell, such as a coin cell. Cell testing is performed on the battery cell to determine if the battery cell meets the target cell properties of the battery cell. The target cell properties include internal resistance, voltage, capacity, and cycle life, among others. The capacity of a battery or battery cell is a measure of the charge stored by the battery and is determined by the mass of active material contained in the battery. The capacity represents the maximum amount of charge that can be extracted from the battery under certain specified conditions. The battery has a discharge current in the amperes that can be delivered over time. The capacity of the battery is given in ampere-hours (Ah).

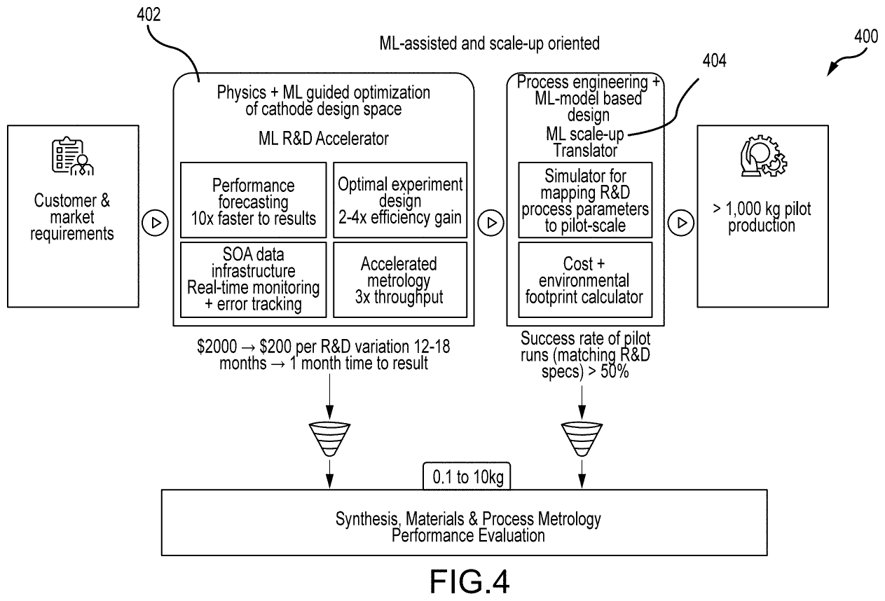

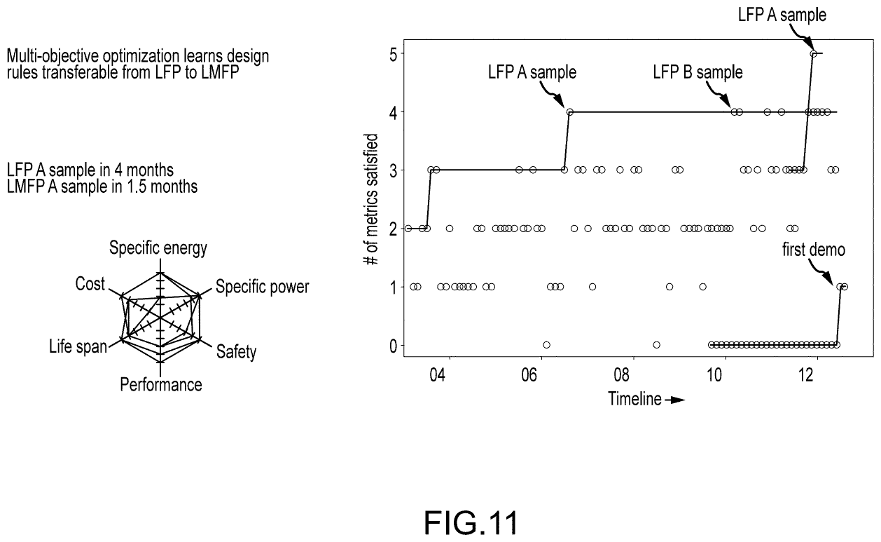

FIG. 4 illustrates a machine learning-assisted and scale-up-oriented approach according to an embodiment of the disclosure. As shown in FIG. 4, an ML-assisted approach and scale-up-oriented approach 400 uses a combination of physics and ML-guided optimization for cathode design. Examples are provided in FIGS. 11-18 to illustrate how ML-assisted and scale-up-oriented approach 400 accelerates the development of new cathode materials to meet customer demands.

ML-assisted and scale-up-oriented approach 400 includes an ML accelerator 402 for speeding up the process of cathode design. ML accelerator 402 can help reduce the number of experiments performed for cathode synthesis, and qualifications at both powder level and cell levels. The ML accelerator 402 can reduce the overall time from cathode design to powder production to about 10 times faster than conventional experimental methods without using ML. The ML accelerator 402 can also gain about two to four times in efficiency than conventional experimental methods without using ML by designing optimal experiments. The ML accelerator 402 includes accelerated and automated metrology which yields about three times throughput than conventional experimental methods without using ML. For example, the ML accelerator 402 may reduce the research and development time from 12-18 months to 1 month to obtain the result. The ML accelerator 402 may also reduce the cost from $2000 to $200 per cathode variation or powder variation.

Also, the ML-assisted and scale-up-oriented approach 400 uses a combination of process engineering and ML model-based design. The ML-assisted and scale-up-oriented approach 400 includes a scale-up translator 404. The ML scale-up translator 404 includes an ML model-based simulator for mapping research and development processing parameters to pilot-scale production. The ML scale-up translator 404 also includes a calculator for cost plus environmental footprint, such as environmental temperatures and relative humidity, among others. For example, the ML scale-up translator may have a success rate of pilot runs greater than 50%. The 50% is an “aspirational” probability of success for scaling up a synthesis process from the R&D scale to the pilot scale.

A pilot production includes synthesis, materials and process metrology, and performance evaluation. For example, the pilot product includes synthesis, powder metrology, cell prototyping, and cell testing as illustrated in FIG. 3. To meet the customer and market requirements, the pilot production is estimated to be greater than about 1000 kg by volume. However, using the ML-assisted and scale-up-oriented approach 400, the pilot production can be reduced from about 1000 kg to about 0.1 kg to about 10 kg.

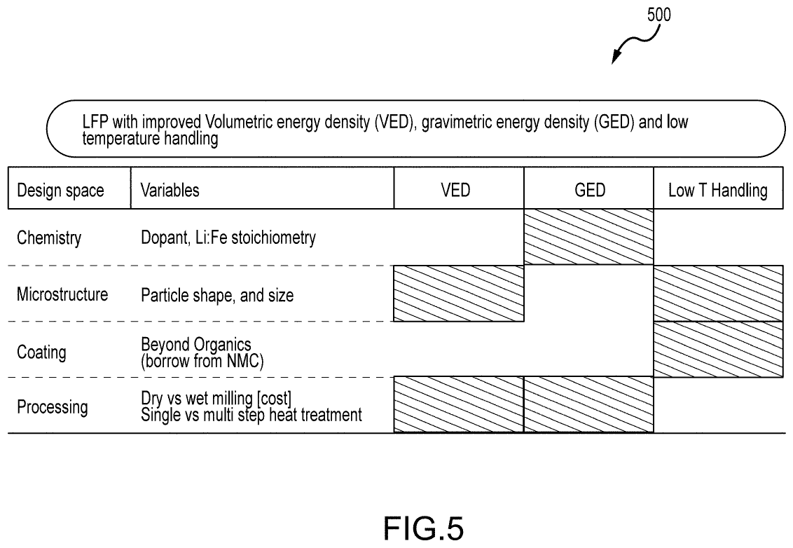

FIG. 5 illustrates the approach for developing lithium iron phosphate (LFP) with improved volumetric energy density (VED), gravimetric energy density (GED), and low-temperature handling according to an embodiment of the disclosure. The gravimetric energy density (GED) of a battery or battery cell is a measure of how much energy the battery contains in comparison to its weight and is typically expressed in Watt-hours/kilogram (W-hr/kg). The volumetric energy density (VED) of a battery or battery cell is a measure of how much energy the battery contains in comparison to its volume and is typically expressed in Watt-hours/liter (W-hr/liters).

As shown in FIG. 5, the variables for chemistry may include a dopant and LiFe stoichiometry, among others. The variables for microstructure may include particle shape and particle size, among others. The variables for coating are like for ternary cathode materials (NMC) which have nickel, manganese, and cobalt as their principal components for lithium-ion batteries. NMCs are used mainly in batteries for electric cars, including hybrid vehicles. The variables for processing may include dry versus wet milling and costs, and a single-step heat treatment versus multiple-step heat treatment.

Also, as shown in FIG. 5, the variables for microstructure and processing may vary to optimize the VED, the variables for chemistry and processing may vary to optimize the GED, and the variables for microstructure and coating may vary for low-temperature handling.

The cathode products of the present technology are targeted as the segments between low-grade lithium iron phosphate (LFP) and ternary cathodes, such as NMC or lithium nickel-cobalt-aluminum oxide (NCA). The cathode products of the present technology are targeted to be better than major industry-standard cathode products either in product pricing or in energy density.

The target cathode products fill an unmet need in the market in terms of the energy density (Wh/liter) and cost ($/kWh) tradeoff. The target cathode products can achieve comparable pack-level performance as NMC and offer improved tap density and improved energy density by up to 20%+ through a combination of cation and polyanion chemistry changes.

The target cathode products may include lithium-metal-phosphates (LMP), where M represents a transition metal or two or more transition metals.

In some variations, the transition metal comprises iron or manganese.

In some variations, the target cathode products may include lithium metal polyanion.

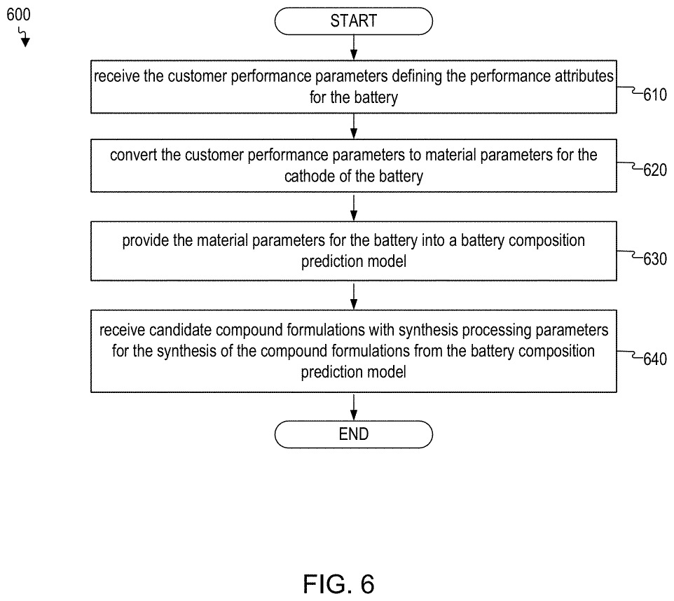

FIG. 6 illustrates an example method 600 for reducing the time and cost of developing a cathode powder meeting custom performance parameters defining performance attributes for a battery. Although the example method 600 depicts a particular sequence of operations, the sequence may be altered without departing from the scope of the present disclosure. For example, some of the operations depicted may be performed in parallel or in a different sequence that does not materially affect the function of method 600. In other examples, different components of an example device or system that implements method 600 may perform functions at substantially the same time or in a specific sequence.

According to some examples, method 600 may include receiving the customer performance parameters defining the performance attributes for the battery at block 610. For example, processor 210 illustrated in FIG. 2 may receive the customer performance parameters defining the performance attributes for the battery.

According to some examples, method 600 includes converting the customer performance parameters to material parameters for the cathode of the battery at block 620. For example, processor 210 illustrated in FIG. 2 may convert the customer performance parameters to material parameters for the cathode of the battery. For example, the processor 210 may use an algorithm in a battery composition prediction model to convert the customer performance parameters to material parameters for the cathode of the battery. The According to some examples, method 600 may include providing the material parameters for the battery into a battery composition prediction model at block 630. For example, processor 210 illustrated in FIG. 2 may provide the material parameters for the battery in a battery composition prediction model.

For example, processor 210 may perform Bayesian optimization based on the material parameters for the cathode to identify the candidate compound formulations and the processing parameters. Therefore, the number of potential candidate compound formulations for synthesis and experimentation is reduced.

According to some examples, method 600 may include receiving candidate compound formulations with synthesis processing parameters for the synthesis of the compound formulations from the battery composition prediction model at block 640. For example, processor 210 illustrated in FIG. 2 may receive candidate compound formulations with synthesis processing parameters for the synthesis of the compound formulations from the battery composition prediction model. The candidate compound formulations will be used for experiments of generating cathode powders, coin cells, and pouch cells. Examples of powder synthesis are provided in iv. Example Powder Synthesis Workflow.

iv. Example Powder Synthesis Workflow

The following examples are for illustration purposes only. It will be apparent to those skilled in the art that many modifications, both to materials and methods, may be practiced without departing from the scope of the disclosure.

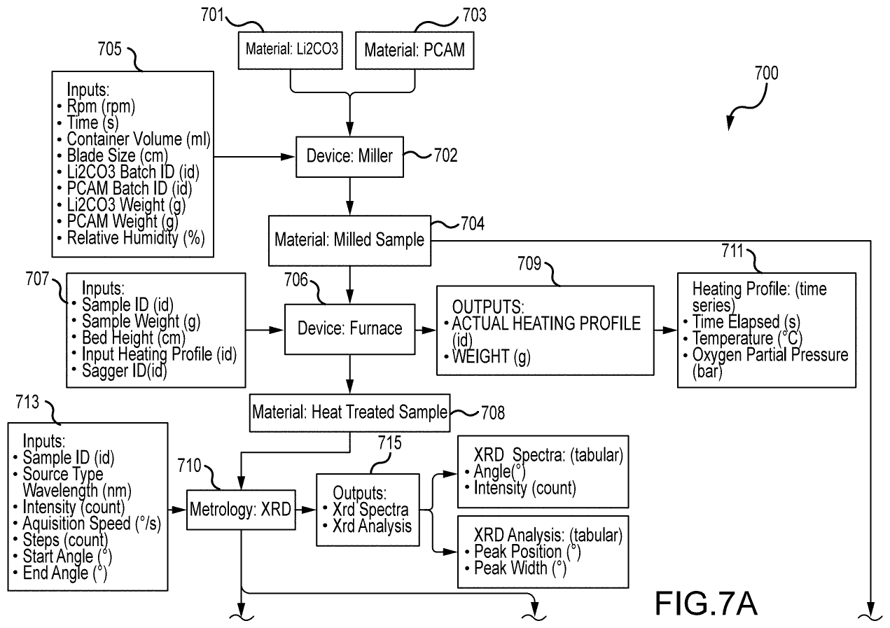

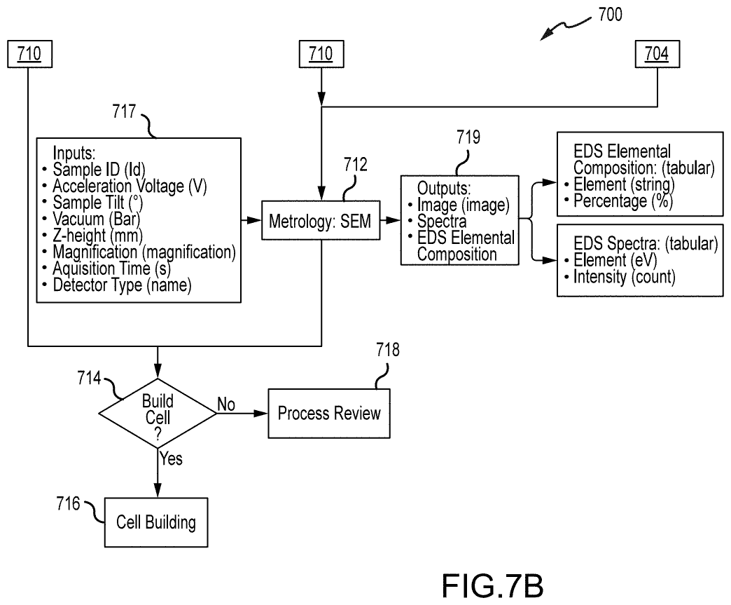

FIG. 7A illustrates steps for powder synthesis according to an embodiment of the disclosure. Powder synthesis process 700 is a simplified workflow, starting with raw materials and ending with the decision-making on whether to use the cathode material (e.g., cathode powder) to build a battery cell, such as a coin cell or a pouch cell. Some inputs, such as weights for a mixer or miller 702, Sagger ID for the furnace 706, may be input manually into the miller by the persons skilled in the art. Other inputs, such as heat profile for furnace 706 or scanning electron microscope (SEM) configuration for SEM 712, may be a selection of pre-defined configurations. Some outputs may be single data points, but many outputs may be time series, such as actual heating profiles, or elemental compositions in a tabular form.

As shown in FIG. 7A, powder synthesis process 700 includes mixing first and second raw materials 701 and 703, such as lithium carbonate Li₂CO₃ and precursor cathode active materials (PCAM), in a mixer device, a milling device, or a miller 702. Li₂CO₃ is an inorganic compound. PCAM is a mixed-metal hydroxide of nickel, cobalt, and other chemical elements. The amounts of raw materials 701 and 703 are selected from a large number of samples based on a battery composition prediction model. The battery composition prediction model can output a variety of possible cathode materials or compounds and process parameters along with a confidence value indicating confidence that a cathode powder created using the cathode materials or compounds and synthesized with the process parameters will meet the required material parameters of the battery cell that were input into the battery composition prediction model. In some embodiments, only a subset of the output of possible cathode materials or compounds and process parameters that are associated with the highest confidence values are selected for synthesis.

Inputs 705 for the milling device 702 may include revolutions per minute (RPM), time in seconds (s), container volume in milliliters (ml), blade side in centimeters (cm), lithium carbonate Li₂CO₃ Batch Identification (ID), PCAM Batch Identification (ID), Li₂CO₃ weight in grams (g), PCAM weight in grams (g), and relative humidity in percentages (%), among others. Some of the inputs, such as Li₂CO₃ weight in grams (g), PCAM weight in grams (g), are outputs from the battery composition prediction model.

Powder synthesis process 700 also includes forming milled samples 704, created by raw materials, such as Li₂CO₃ 701 and PCAM 703. The milled sample 704 including cathode powder can be analyzed by material characterization as illustrated in FIG. 7B. Powder synthesis process 700 also includes heat treating the mixed sample in a heat treatment device or a furnace 706. Inputs 707 for furnace 706 may include sample identification (ID), sample weight (e.g., in g), bed height (e.g., in cm), input heating profile, Sagger ID, among others. Outputs 709 from furnace 706 may include the actual heating profile and weight (g), among others. The actual heating profile 711 includes time elapsed, temperature (e.g., in ° C.), and oxygen partial pressure (e.g., in bars), among others. Powder synthesis process 700 also includes forming heat-treated samples 708. Some of the inputs 707, such as the input heating profile, are synthesis processing parameters or variables, which are outputs from the battery composition prediction model. The actual heating profile can be provided to train the battery composition prediction model, which is also referred to as an active learning model, which can generate inputs, such as an input heating profile based on inputs that have been previously used in training the active learning model.

FIG. 7B is a continuation of FIG. 7A and illustrates steps for material characterizations of powder and decision-making for coin cell building according to an embodiment of the disclosure. Powder synthesis process 700 also includes characterizing the heat-treated sample 708 by metrology including X-ray diffraction analyses (XRD) 710, which is an analytical technique used in materials sciences to determine the crystal structure, chemical composition, and physical properties of a material. XRD is based on the constructive interference of monochromatic X-rays and a crystalline sample. X-rays are shorter wavelength electromagnetic radiation that is generated when electrically charged particles with sufficient energy are decelerated. In XRD, the generated X-rays are collimated and directed to a material sample, where the interaction of the incident rays with the sample produces a diffracted ray, which is then detected, processed, and counted. The intensity of the diffracted rays scattered at different angles of material is plotted to display a diffraction pattern.

Inputs 713 for operating the XRD 710 include sample ID, source type wavelength (nm), intensity (count), acquisition speed, steps (count), start angle)(°, and end angle)(°, among others. Outputs 715 from the XRD 710 include XRD spectra including angle)(° and intensity (count). Which may be presented in a tabular form. Outputs 715 from the XRD 710 also include XRD analysis including peak position)(° and peak width)(°, which may be presented in a tabular form.

In some embodiments, the XDR 710 can be performed automatically on the cathode powder samples. The output 715 can be fed back into the battery composition prediction model as additional measured data to improve future predictions.

Powder synthesis process 700 also includes characterizing the heat-treated sample 708 by metrology including scanning electron microscopy (SEM) 712, which is a powerful analytical technique to perform analysis on a wide range of materials, at high magnifications, and to produce high-resolution images. Energy-dispersive X-ray spectroscopy (EDS) is an analytical technique that enables the chemical characterization/elemental analysis of materials. A sample excited by an energy source, such as the electron beam of an electron microscope, dissipates some of the absorbed energy by ejecting a core-shell electron. A higher energy outer-shell electron then proceeds to fill its place, releasing the difference in energy as an X-ray that has a characteristic spectrum based on its atom of origin. This allows for the compositional analysis of a given sample volume that has been excited by the energy source. The position of the peaks in the spectrum identifies the element, whereas the intensity of the signal corresponds to the concentration of the element.

EDS is sensitive to low concentrations with detection limits below 0.1%. EDS affords a high degree of relative precision, for example, about 2% to about 4%. EDS is non-destructive in most situations. EDS also requires minimal sample preparation effort and time and delivers complete analyses of complex samples quickly, often in under a minute.

Inputs 717 for operating the SEM 712 include sample ID, acceleration voltage (V), sample tilt angle (°), vacuum (bar), Z-height (mm), magnification, acquisition time (second), and detector type (name), among others. Outputs 719 from the SEM 712 include images, spectra, and EDS elemental compositions. The EDS elemental composition including elements and their percentages (%) presented in tabular form. The EDS spectra including energy (eV) and intensity (count) are also presented in a tabular form.

In some embodiments, SEM 712 can be performed automatically on the cathode powder samples. The output 719 can be fed back into the battery composition prediction model as additional measured data to improve future predictions.

The material characterizations include outputs 715 from XRD 710 and also outputs 719 from SEM 712, which are provided to processor 210 for further analyses. The analyses can include selecting potential candidate powders for building battery cells, such as coin cells or pouch cells. The selection of potential candidate powders for building battery cells can also be performed by a human technician. Coin cells are battery cells in the form of small stainless-steel discs. Pouch cells are battery cells that typically use polymer-coated aluminum foil casings rather than metal casings. The polymer-coated aluminum foil casings make pouch cells lightweight and enable the pouch cells to conform to their enclosure modestly.

Powder synthesis process 700 further includes deciding whether to build a battery cell at block 714 based on the analysis of metrology including XRD and SEM, among others. If a decision is “Yes”, then powder synthesis process 700 includes building the battery cell at block 716. If a decision is “No”, then powder synthesis process 700 includes reviewing the process to block 718.

v. Example Workflow for Building Coin Cell or Pouch Cell from New Cathode Powder

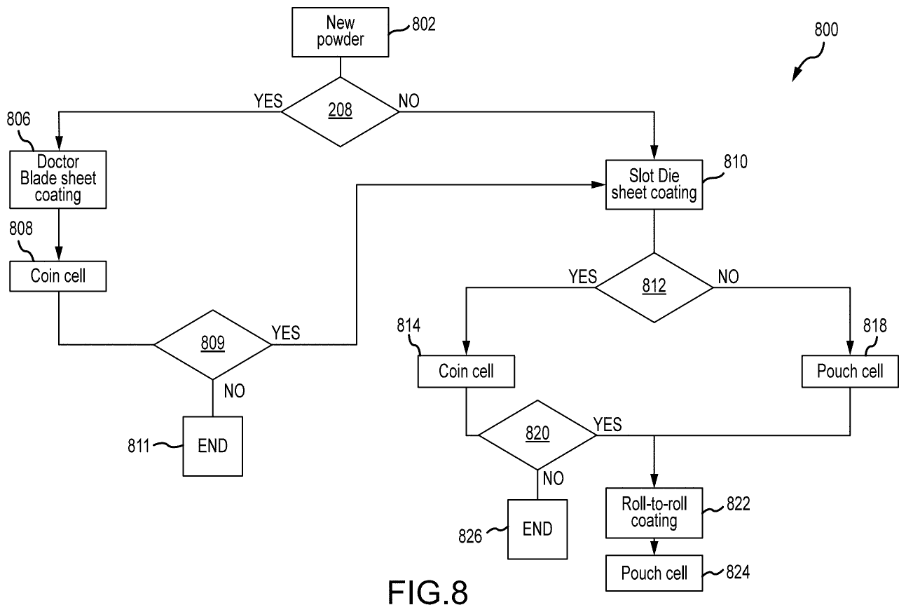

For any of the potential candidate powders selected based on decision 716 as shown in FIG. 7B, steps for coin cell testing and decision-making for pouch cell building according to an embodiment of the disclosure are depicted in FIG. 8. As shown, a cell testing decision process 800 includes providing a new powder 802. One of the persons skilled in the art may decide if quick trials are needed or not at block 804. For example, if one of the persons skilled in the art does not know whether the new powder would work, cell testing decision process 800 includes doctor blade coating at block 806 and building coin cell 808, and performing cell testing to collect cell data. The doctor blade coating is a technique used to form sheets or films with defined thicknesses. The technique uses a sharp blade at a fixed distance from a surface that will be covered. The coating solution is then placed in front of the blade and the blade is moved across in line with the surface, creating a wet film or sheet.

If preliminary cell data look promising at block 809, one of the persons skilled in the art intends to get more controlled cell data, then cell testing decision process 800 includes slot die sheet coating at block 810. If preliminary cell data do not look promising at block 809, cell testing decision process 800 ends at block 811 and may include a further review of the process.

If one of the persons skilled in the art is familiar with coating a powder and intends to collect pouch cell data, then cell testing decision process 800 includes slot-die sheet coating at block 810, following the step of providing a new powder 802. The slot-die sheet coating is a coating technique for the application of solution, slurry, or extruded thin films onto typically flat substrates such as glass, metal, paper, fabric, or plastic foils. If one of the persons skilled in the art intends to determine if the new powder 802 stands for any environmental testing condition at block 812, then cell testing decision process 800 includes testing a coin cell under any environmental testing condition at block 814.

If one of the persons skilled in the art decides to have a full evaluation of the new powder 802 under environmental conditions or a more accurate comparison with other similar powders at block 820, then cell testing decision process 800 includes roll-to-roll coating at block 822 and building pouch cell and evaluating the pouch cell under the environmental conditions at block 824. The roll-to-roll coating is a fabrication method used in manufacturing that coats, prints, or laminates various fluid materials onto a flexible rolled substrate material as that material is fed continuously from one roller to another roller. If one of the persons skilled in the art decides not to have a full evaluation of the new powder 802 under environmental conditions at block 820, the cell testing decision process 800 ends at block 826.

Alternatively, if one of the persons skilled in the art has a specific testing condition and likes to determine if the new powder 802 improves in a particular environmental testing condition at block 812, then cell testing decision process 800 may include building a pouch cell and testing the pouch cell in the particular environmental testing condition at block 818.

vi. Example Battery Cells

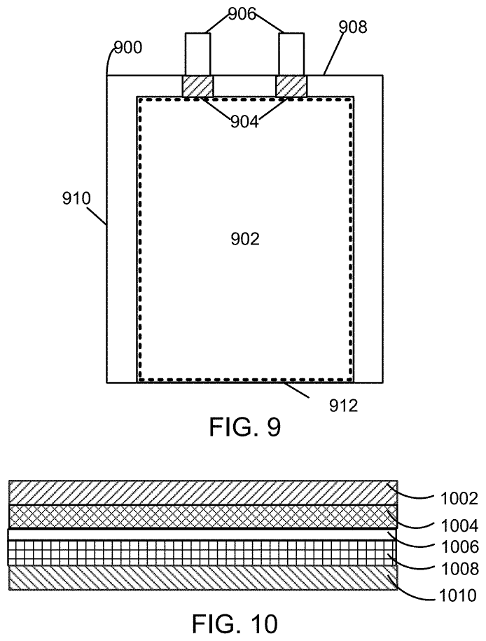

FIG. 9 illustrates a top-down view of a battery cell 900 according to an embodiment of the disclosure. The battery cell 900 may correspond to a lithium-ion battery cell that is used to power a device used in a consumer, medical, aerospace, defense, transportation, or other application.

The battery cell 900 includes a stack 902 containing a number of layers that include a cathode with a cathode active material, a separator, and an anode with an anode active material. More specifically, stack 902 may include one strip of cathode active material (e.g., aluminum foil coated with a lithium compound) and one strip of anode active material (e.g., copper foil coated with carbon). Stack 902 also includes one strip of separator material (e.g., conducting polymer electrolyte) disposed between the one strip of cathode active material and the one strip of anode active material. The cathode, anode, and separator layers may be left flat in a planar configuration.

Enclosures can include, without limitations, pouches, such as flexible pouches, rigid containers, and the like. Returning to FIG. 9, during the assembly of the battery cell 900, stack 902 is enclosed in an enclosure. Stack 902 may be in a planar or wound configuration, although other configurations are possible.

Stack 902 can also include a set of conductive tabs 906 coupled to the cathode and the anode. The conductive tabs 906 may extend through seals in the enclosure (for example, formed using sealing tape 904) to provide terminals for the battery cell 900. The conductive tabs 906 may then be used to electrically couple the battery cell 900 with one or more other battery cells to form a battery pack. The battery cell 900 may be a coin cell. The battery cell may be used for battery electric vehicles. The battery cell 900 may also be a pouch cell.

Batteries can be combined in a battery pack in any configuration. For example, the battery pack may be formed by coupling the battery cells in a series, parallel, or series-and-parallel configuration. Such coupled cells may be enclosed in a hard case to complete the battery pack or may be embedded within an enclosure of a portable electronic device, such as a laptop computer, tablet computer, mobile phone, personal digital assistant (PDA), digital camera, and/or portable media player.

FIG. 10 illustrates a side view of a set of layers for a battery cell according to an embodiment of the disclosure. The set of layers may include a cathode current collector 1002, a cathode active material 1004, a separator 1006, an anode active material 1008, and an anode current collector 1100. The cathode current collector 1002 and the cathode active material 1004 may form a cathode for the battery cell, and the anode current collector 1100 and the anode active material 1008 may form an anode for the battery cell. To create the battery cell, the set of layers may be stacked in a planar configuration or stacked and then wrapped into a wound configuration.

As mentioned above, the cathode current collector 1002 may be aluminum foil, the cathode active material 1004 may be a lithium compound, the anode current collector 1100 may be a copper foil, and the anode active material 1008 may be carbon, and the separator 1006 may include a conducting polymer electrolyte.

vii. Example Hierarchical Material Screening Workflow

FIG. 11 illustrates demonstrated success in scaleup acceleration according to an embodiment of the disclosure. When customers provide requirements, such as specific energy, specific power, performance, life span, safety, and cost, developments of a target battery cell including cathode powders are accelerated by using an optimization approach. The optimization learns design rules, which are transferable across battery cathode compounds such as from lithium iron phosphate (LFP) to lithium manganese iron phosphate (LMFP), from LFP to other polyanion cathodes for Li-ion batteries, or from LFP cathode powders to LMFP cathode powders to other polyanion cathode powders for Li-ion batteries among others.

For example, the optimization learns design rules, which are transferable from LFP to LMFP. LFP A sample (1 kg) was developed in about 4 months, while an LMFP A sample was obtained in about 1.5 months. This acceleration in developing LMFP was obtained based on the design rules learned from LFP learned from LFP which are transferrable from LFP to LMFP.

As shown in FIG. 11, LFP A sample (small batch) was developed in about 4 months, starting from March. The LFP B sample (large batch) was developed after the LFP A sample (small batch), starting in July. The optimization learns design rules, which are transferable from LFP to another polyanion cathode for Li-ion battery. Another polyanion cathode was developed faster than LFP A sample. For example, another polyanion cathode for Li-ion batteries started in October, and the first polyanion cathode for Li-ion batteries demo was obtained in December, which was about 2 months shorter than the 4 months for developing the LFP A sample. This acceleration in developing other polyanion cathodes for Li-ion batteries was obtained based on the design rules learned from LFP which are transferrable from LFP to other polyanion cathodes for Li-ion batteries.

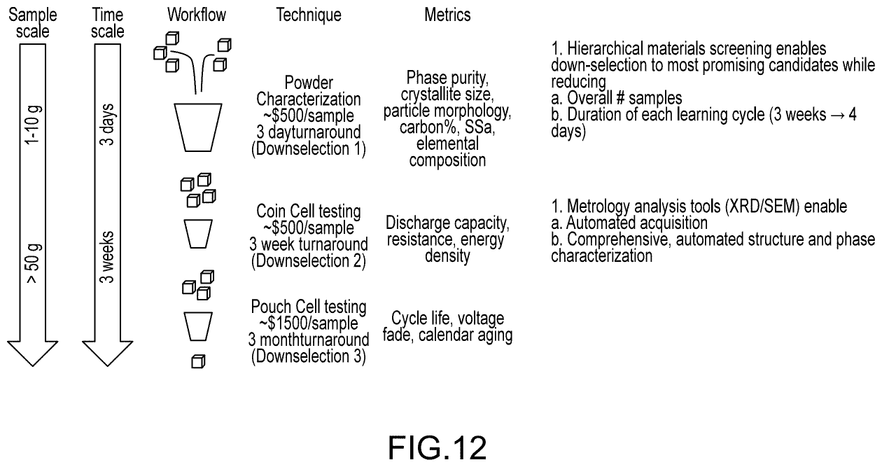

FIG. 12 illustrates a hierarchical material screening workflow for fast timelines and resource-efficient selections of cathode designs according to an embodiment of the disclosure. The hierarchical material screening enables down-selection to the most promising candidates while reducing the overall number of samples and thus reducing the duration of each learning cycle from about three weeks to about four days. The metrology analysis tools, such as XRD and SEM, enable the automated acquisition and comprehensive, automated structure and phase characterization.

As illustrated, the sample scale initially starts with 1 g-10 g for cathode powder characterization with a three-days turnaround time at the first stage, e.g., downselection 1. The cost of the powder characterization is relatively low, e.g., about $500 per sample. The material characterizations for the cathode powders include phase purity, crystallite size, particle morphology, carbon %, specific surface area (SSA), and elemental composition, among others.

Then, the sample scale increases to 10 g-50 g for coin cell testing with a three-week turnaround time at a second stage, e.g., downselection 2. The coin cell testing determines the discharge capacity, resistance, and energy density, among others.

After the coin cell testing, the sample scale increases to 50 g-500 g for pouch cell testing with a three-month turnaround time at a third stage, e.g., downselection 3. The pouch cell testing evaluates cycle life, voltage fade, and calendar aging, among others, under various environmental conditions.

Different sample batches start at different times based on decisions as described related to FIG. 8. For example, the first batch is a small batch of about 1 g-10 g for making LFP cathode powders. A second batch is a medium size of about 10 g-50 g for making coin cells. A third batch is a large size of about 50 g-500 g for making pouch cells. The batch size is correlated to how mature the chemistry and process are.

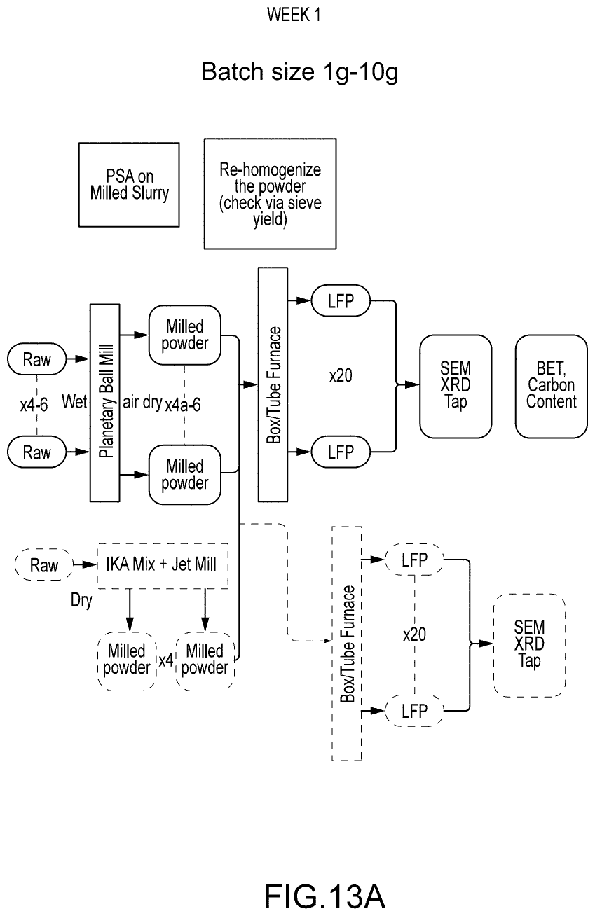

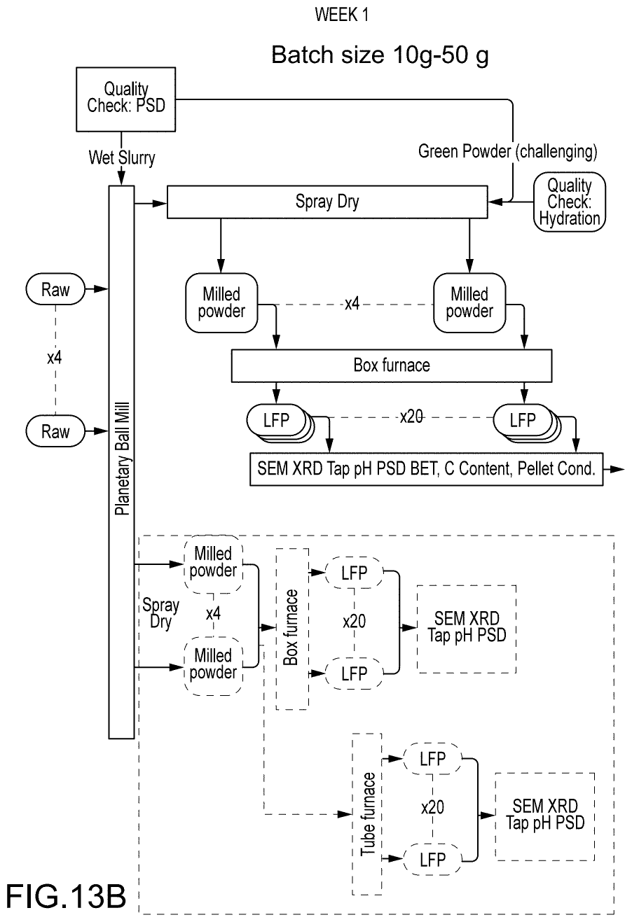

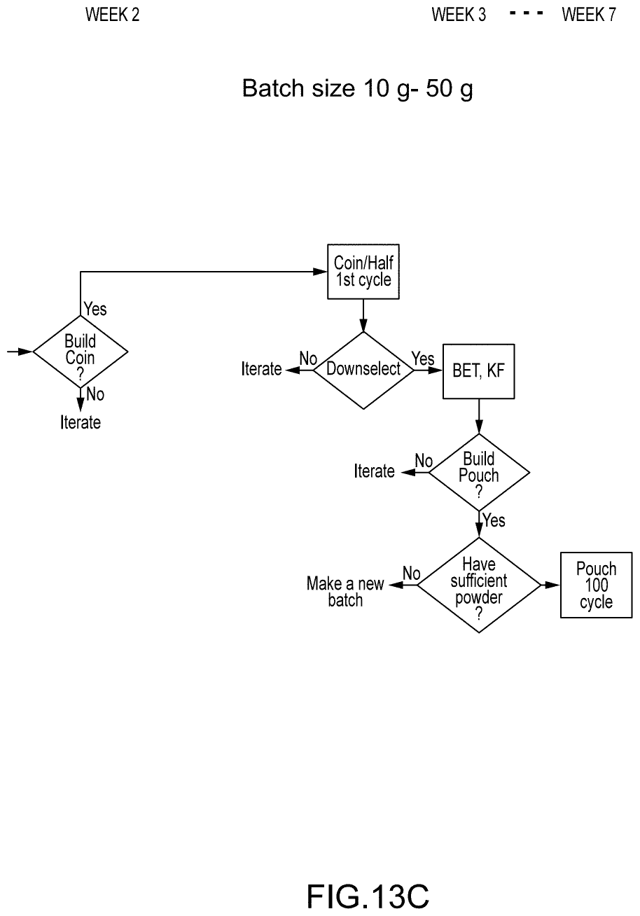

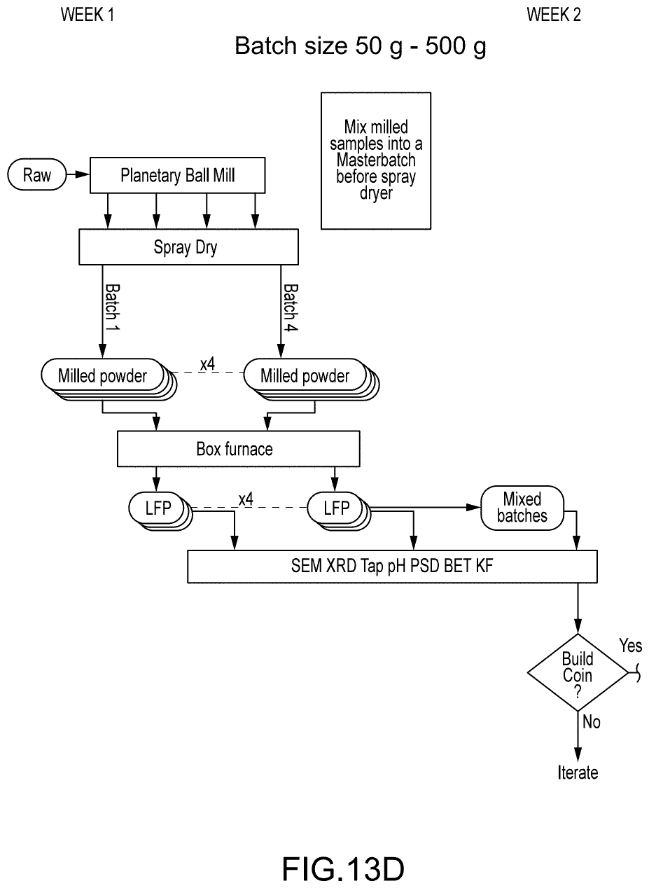

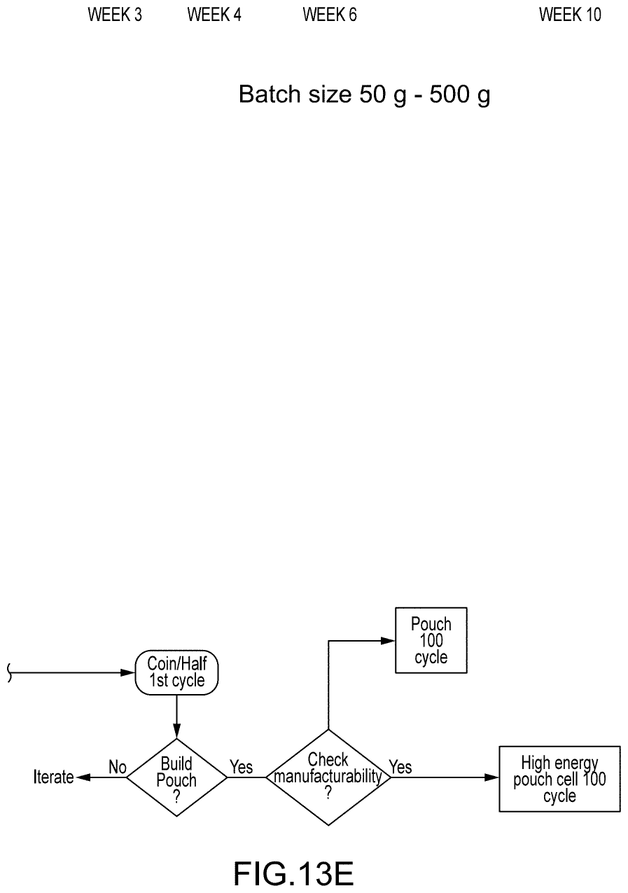

FIG. 13A illustrates a workflow in week 1 for a batch size of about 1 g-10 g according to an embodiment of the disclosure. As shown, particle size analysis (PSA) is performed on milled slurry. 4 to 6 raw materials or compounds are fed into a planetary mill for wet milling, then air-dried to generate 4 to 6 variations of milled powders, which are placed in the box furnace or tube furnace for calcination at different processing conditions (e.g., 5 different conditions) to generate various variations of LFP powders (e.g., 20 variations), which are analyzed by SEM, XRD, tap density, BET, carbon content, among others.

Alternatively, raw materials can be mixed in IKR mix and Jet Mill (dry mill) to generate 4 variations of milled powders, followed by calcination in a box furnace or a tube furnace to generate 20 variations of LFP cathode powders at various processing conditions.

Then, raw material, intermediates, and calcination conditions are correlated to material characteristics or properties (e.g., phase purity, elemental composition, and microstructure, among others) of primary particles.

Particles can include primary and secondary particles. Primary particle and secondary particle size distribution, shape, and porosity can impact the density of the cathode of a battery cell. Secondary particles are comprised of agglomerates of the smaller, primary particles, which are also often referred to as grains. The morphology of particles can influence the performance of cathode-active materials.

FIG. 13B illustrates a workflow in week 1 for a batch size of about 10 g to 50 g according to an embodiment of the disclosure. Note that this week 1 does not start at the same time as for the small batch of 1 g to 10 g, but week 1 starts according to the decision as described in FIG. 8. For a batch size of 10 g to 50 g, particle size distribution (PSD) is checked first before the wet slurry is fed into a planetary ball mill. Various design variations (e.g., 4 design variations) of raw materials or compounds are milled, and then spray dry to generate various variations of milled powders (e.g., 4 variations), which are fed into a box furnace to generate 20 variations of LFP powders (e.g., 4 variations) at 5 processing variations, which is characterized by SEM, XRD, tap density, pH values, PSD, BET, carbon content, pellet condition, among others.

Alternatively, as shown in the dashed box, the milled powders after spray drying are fed into a box furnace or a tube furnace to generate 20 variations of LFP powders at various processing variations (e.g., 5 processing variations). For example, each design of raw materials or compounds is processed at 5 processing variations.

The 20 variations of LFP powders are analyzed by SEM, XRD, tap density, pH values, and PSD to obtain the properties of the powders. Then, properties of primary particles, and spray drying conditions are correlated to material characteristics or properties of secondary particles, such as phase purity, pH value, tap density, morphology, and PSD, among others.

FIG. 13C is a continuation of the workflow of FIG. 13 B for the batch size of 10 g to 50 g from week 2 to week 7 according to an embodiment of the disclosure. As shown, based on the material characterizations of powders, after a decision is made to build a coin cell in week 2, a first cycle test is performed on the coin cell in week 3. Then, particle properties are correlated to initial coin cell performance.

Based on the performance of the coin cells, the number of coin cells is reduced. Then, after BET and KF, a pouch cell may be built for cycle tests, for example, 100 cycles. Then, particle properties are corrected to the aging performance of the pouch cells after the pouch cycle tests.

FIG. 13D illustrates a workflow from week 1 to week 2 for a batch size of 50 g to 500 g according to an embodiment of the disclosure. Note that this week 1 does not start at the same time as for the small batch of 1 g to 10 g, but week 1 starts according to the decision as described in FIG. 8. As shown, in week 1 and week 2, 1 raw material or compound is fed into a planetary ball mill. Note that the number of raw materials or compounds is reduced from 4 to 6 for the small batch of 1 g to 10 g to reduce to 1 for the large batch of 50 g to 500 g. The milled samples may be mixed into a master batch before spray drying. The mixed milled samples are spray dry in batches 1-4 to generate four variations of milled powders, which are placed in a box furnace for calcination at different processing conditions or processing variations to yield 4 variations of LFPs. Then, various material characterizations are performed for each patch of LFP and the mixed batches, including SEM, XRD, tap density, pH values, particle size distribution (PSD), Brunauer-Emmett-Teller (BET), Karl Fischer (KF) titration, among others. Based on the material characterizations, the batches may be built into coin cells.

FIG. 13E is a continuation of the workflow of FIG. 13D for the batch size of 50 g to 500 g from week 3 to week 10 according to an embodiment of the disclosure. Scale-up batch-to-batch variations and process windows are studied in weeks 6 to 7. The manufacturability of the pouch cell is checked by building pouch cells for cycle performance, e.g., 100 cycles. Powder properties are correlated to manufacturability in week 8 to week 9. In week 10, high-energy pouch cells run through 100 cycles.

A process for generating cathode powders, such as lithium iron phosphate (LFP) or lithium manganese iron phosphate (LMFP) powders. includes wet miffing (e.g., miffing in water) to form milled slurry In this process, processing variables include precursor (e.g., Li, Fe, Mn, P, C) sources and amounts, mill time, milling speed, and milling bead size, among others, which are tuned to optimize the metrics including slurry viscosity, pH, particle size, among others.

The process also includes spray drying to form a spray-dried powder. processing variables include nozzle type, slurry flow rate, inlet and outlet temperatures, among others, which are tuned to optimize the metrics including particle size, particle shape, or moisture content, among others

The process also includes calcination in a furnace to form a compound, such as an LMFP compound or LMFP powder. Processing variables include hold temperatures and hold times, temperature ramp rates, and oxygen level, among others, which are tuned to optimize the metrics including surface area, carbon content, tap density, crystallite size, and phase purity, among others.

The process also includes cell-making using the cathode powders and cell testing to obtain the target metrics including C/10 specific discharge capacity and 2C specific discharge capacity, among others.

viii. Example Results from Bayesian Active Learning and Validation Experiments

Bayesian optimization is used to simultaneously optimize specific surface area, C %, 0.1C discharge energy, and 2C discharge energy over a vast design pace spanning milling energy, milling time, solids wt % loading, calcination time, calcination temperature, calcination pO2, amounts of precursors of Fe, Li, Mn, and P.

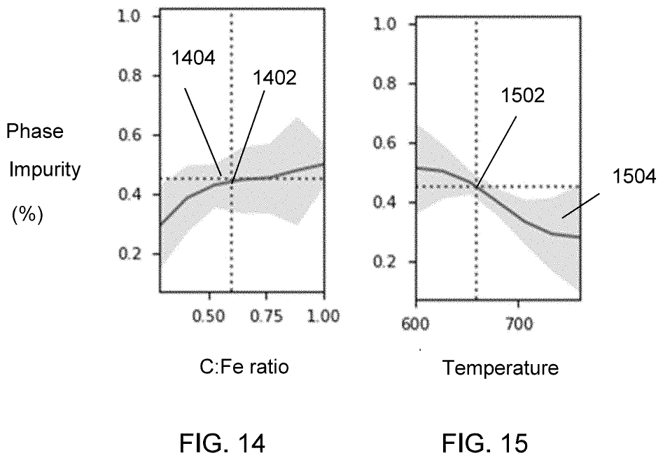

FIG. 14 illustrates finding optimal process parameters for the synthesis of a cathode powder weighing aspects of phase impurity versus the ratio of carbon (C) to iron (Fe) using active learning from a battery composition prediction model according to an embodiment of the disclosure. The battery composition prediction model may use Bayesian active learning to help find optimal experimental settings more quickly than without the use of Bayesian active learning. Inputs include various C:Fe ratios among other variables. Bayesian active learning creates phase impurity variation band 1404. Outputs from the Bayesian active learning include a cross point 1402 with about 0.6 ratios of C:Fe and about 0.45 phase impurity, which is considered the optimal experimental setting for the compound synthesis design (e.g., C:Fe ratio) based on active learning using the battery composition prediction model.

FIG. 15 illustrates finding optimal process parameters for the synthesis of a cathode powder weighing aspects of phase impurity and calcination temperature using active learning from a battery composition prediction model according to an embodiment of the disclosure. The battery composition prediction model may use Bayesian active learning to help find optimal experimental settings more quickly than without the use of Bayesian active learning. Inputs include various calcination temperatures among other variables. Bayesian active learning creates phase impurity variation band 1504 versus calcination temperature. Outputs from the Bayesian active learning include a cross point 1502 with about 660° C. calcination temperature and about 0.45 phase impurity is considered the optimal experimental setting for the processing parameter (e.g., calcination temperature) based on the active learning using the battery composition prediction model.

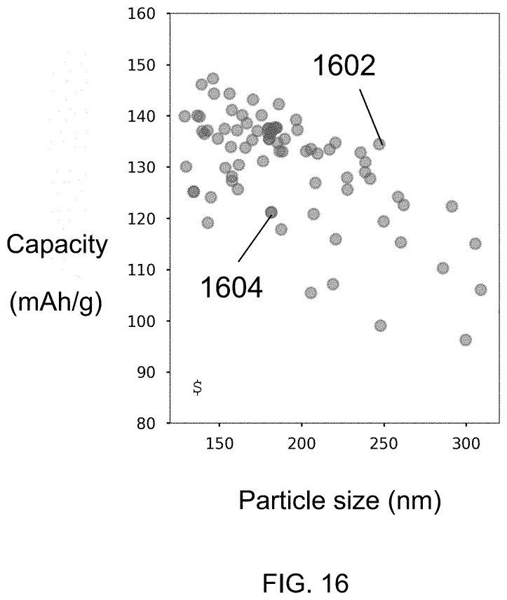

FIG. 16 illustrates discharge capacity versus particle size according to an embodiment of the disclosure. The discharge capacity can be obtained after cell testing, which takes 3 weeks. The particle size can be obtained after 3 days, much faster than cell testing. The particle size or crystallite size can be computed from the analysis of XRD spectra of prepared cathodes. The discharge capacity can be measured from electrochemical testing of half coin cells. As shown in FIG. 16, light gray circle 1602 are training points while dark gray circle 1604 are validation points. There are fewer dark gray points than the training points based on active learning. By using a combination of Bayesian active learning and experimental validations, smaller particle sizes are correlated with high capacities as shown in FIG. 16. As such, the particle size can be used as an early predictor of cell performance. By using the correlation as shown in FIG. 16, cell tests can be reduced based on particle sizes. For example, when a target capacity is 130 mAh/g, large particle sizes above 250 nm can be eliminated.

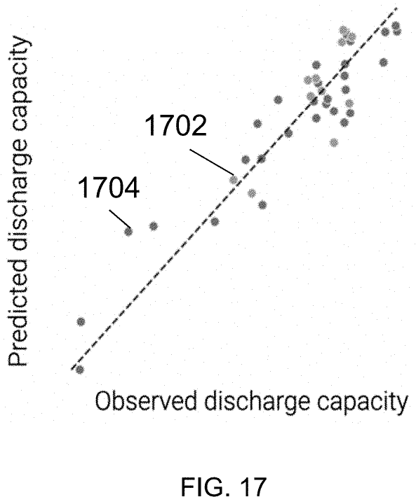

FIG. 17 illustrates correlations between observed discharge capacities and predicted discharge capacities according to an embodiment of the disclosure. The predicted values of the discharge capacity were generated using a supervised ML model that was trained on features obtained from the electrochemical cycling of cells. Specifically, the supervised ML model uses features extracted from the first 30 cycles of charge and discharge of pouch cells and forecasts the performance of pouch cells through the end of their life (e.g., 1000 cycles and beyond). As shown in FIG. 17, light gray circle 1702 represents validation while dark gray circle 1704 represents training points based on modeling. The predicted discharge capacity based on the battery composition prediction model (e.g., using Bayesian active learning) has an approximately linear correlation with the observed discharge capacity. With more observed discharge capacity collected, the model will be more accurate.

Clause 1. A method for reducing the time and cost of developing a cathode powder meeting custom performance parameters defining performance attributes for a battery, the method comprising: receiving the customer performance parameters defining the performance attributes for the battery; converting the customer performance parameters to material parameters for the cathode of the battery; providing the material parameters for the battery into a battery composition prediction model; receiving candidate compound formulations with synthesis processing parameters for the synthesis of the compound formulations from the battery composition prediction model.

Clause 2. The method of clause 1, further comprising: performing Bayesian optimization based on the material parameters for the cathode to identify the candidate compound formulations and the processing parameters.

Clause 3. The method of clause 1, further comprising: selecting a subset of the candidate compound formulations with the processing parameters to be synthesized, whereby a number of potential candidate compound formulations for synthesis and experimentation are reduced.

Clause 4. The method of clause 3, wherein the selected subset of the candidate compound formulations with the processing parameters includes 50% of the candidate compound formulations with the processing parameters having the highest confidence value for meeting the material parameters of the cathode of the battery.

Clause 5. The method of clause 3, wherein the selected subset of the candidate compound formulations with the processing parameters includes 30% of the candidate compound formulations with the processing parameters having the highest confidence value for meeting the material parameters of the cathode of the battery.

Clause 6. The method of clause 3, wherein the selected subset of the candidate compound formulations with the processing parameters includes 20% of the candidate compound formulations with the processing parameters having the highest confidence value for meeting the material parameters of the cathode of the battery.

Clause 7. The method of clause 3, further comprising: generating respective cathode powders from the selected subset of the candidate compound formulations using the processing parameters from the battery composition prediction model; and performing material characterizations on the candidate cathode powders.

Clause 8. The method of clause 7, further comprising: selecting a first subset of the respective candidate cathode powders based on the material characterizations for use in building respective batteries from the first subset of the respective candidate cathode powders.

Clause 9. The method of clause 7, wherein the material characterizations of the cathode powders are performed by using one or more X-ray diffraction analyses (XRD), scanning electron microscopy (SEM), or Energy-dispersive X-ray spectroscopy (EDS).

Clause 10. The method of clause 7, wherein the material characterizations of the cathode powders comprise one or more elemental compositions, phase purity, crystallinity, particle size, surface area, or tap density.

Clause 11. The method of clause 8, further comprising: determining, based on results from the material characterizations of the cathode powders, whether to build candidate coin cells from the first subset of the plurality of candidate cathode powder or determining, based on results from testing the candidate coin cells, whether to build candidate pouch cells from the first subset of the plurality of candidate cathode powders for an evaluation of the candidate powders under the plurality of environmental conditions.

Clause 12. The method of clause 8, further comprising: monitoring performance attributes of the respective test batteries made from the first subset of the respective candidate cathode powders over a first interval; providing data derived from the monitoring of the performance attributes for the respective test batteries made from the first subset of the respective candidate cathode powders over the first interval into a battery performance model; and receiving predicted performance attributes for the test batteries over a second interval that is longer than the first interval.

Clause 13. The method of clause 12, wherein the performance attributes of the battery comprise one or more of internal resistance, voltage, capacity, or cycle life.

Clause 14. The method of clause 7, further comprising: providing the material characterizations on the respective candidate cathode powders as feedback to the battery composition prediction model, whereby the battery composition prediction model is refined based on the feedback.

Clause 15. A compound comprising lithium iron phosphate (LFP), lithium manganese iron phosphate (LMFP), or other polyanion cathodes for Li-ion batteries, wherein the compound is optimized by the method for reducing the time and cost of developing a cathode powder meeting custom performance parameters defining performance attributes for a battery of clause 1.

Clause 16. A particle comprising the compound of clause 15.

Clause 17. A powder comprising a plurality of particles of clause 16.

Clause 18. A cathode comprising a cathode current collector and a cathode active material disposed over the cathode current collector, the cathode active material comprising the compound of clause 15, the particle of claim 16, or the powder of claim 17.

Clause 19. A battery cell comprising: an anode comprising an anode current collector and an anode active material disposed over the anode current collector; and the cathode of clause 18.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed is:

1. A method for reducing the time and cost of developing a cathode powder meeting custom performance parameters defining performance attributes for a battery, the method comprising:
receiving the customer performance parameters defining the performance attributes for the battery;
converting the customer performance parameters to material parameters for the cathode of the battery;
providing the material parameters for the battery into a battery composition prediction model;
receiving candidate compound formulations with synthesis processing parameters for the synthesis of the compound formulations from the battery composition prediction model.

2. The method of claim 1, further comprising:
performing Bayesian optimization based on the material parameters for the cathode to identify the candidate compound formulations and the processing parameters.

3. The method of any one of preceding claims, further comprising:
selecting a subset of the candidate compound formulations with the processing parameters to be synthesized, whereby a number of potential candidate compound formulations for synthesis and experimentation are reduced.

4. The method of any one of preceding claims, wherein the selected subset of the candidate compound formulations with the processing parameters comprises 50% of the candidate compound formulations with the processing parameters having the highest confidence value for meeting the material parameters of the cathode of the battery.

5. The method of any one of preceding claims, wherein the selected subset of the candidate compound formulations with the processing parameters comprises 30% of the candidate compound formulations with the processing parameters having the highest confidence value for meeting the material parameters of the cathode of the battery.

6. The method of any one of preceding claims, wherein the selected subset of the candidate compound formulations with the processing parameters comprises 20% of the candidate compound formulations with the processing parameters having the highest confidence value for meeting the material parameters of the cathode of the battery.

7. The method of any one of preceding claims, further comprising:
generating respective cathode powders from the selected subset of the candidate compound formulations using the processing parameters from the battery composition prediction model; and
performing material characterizations on the candidate cathode powders.

8. The method of any one of preceding claims, further comprising:
selecting a first subset of the respective candidate cathode powders based on the material characterizations for use in building respective batteries from the first subset of the respective candidate cathode powders.

9. The method of any one of preceding claims, wherein the material characterizations of the cathode powders are performed by using one or more X-ray diffraction analyses (XRD), scanning electron microscopy (SEM), or Energy-dispersive X-ray spectroscopy (EDS).

10. The method of any one of preceding claims, wherein the material characterizations of the cathode powders comprise one or more elemental compositions, phase purity, crystallinity, particle size, surface area, or tap density.

11. The method of any one of preceding claims, further comprising:
determining, based on results from the material characterizations of the cathode powders, whether to build candidate coin cells from the first subset of the plurality of candidate cathode powder or determining, based on results from testing the candidate coin cells, whether to build candidate pouch cells from the first subset of the plurality of candidate cathode powders for an evaluation of the candidate powders under the plurality of environmental conditions.

12. The method of any one of preceding claims, further comprising:
monitoring performance attributes of the respective test batteries made from the first subset of the respective candidate cathode powders over a first interval;
providing data derived from the monitoring of the performance attributes for the respective test batteries made from the first subset of the respective candidate cathode powders over the first interval into a battery performance model; and
receiving predicted performance attributes for the test batteries over a second interval that is longer than the first interval.

13. The method of any one of preceding claims, wherein the performance attributes of the battery comprise one or more of internal resistance, voltage, capacity, or cycle life.

14. The method of any one of preceding claims, further comprising:
providing the material characterizations on the respective candidate cathode powders as feedback to the battery composition prediction model, whereby the battery composition prediction model is refined based on the feedback.

15. A compound comprising lithium iron phosphate (LFP), lithium manganese iron phosphate (LMFP), or other polyanion cathodes for Li-ion batteries, wherein the compound is optimized by the method for reducing the time and cost of developing a cathode powder meeting custom performance parameters defining performance attributes for a battery of any one of preceding claims.

16. A particle comprising the compound of claim 15.

17. A powder comprising a plurality of particles of any one of claims 15-16.

18. A cathode comprising a cathode current collector and a cathode active material disposed over the cathode current collector, the cathode active material comprising the compound of claim 15, the particle of claim 16, or the powder of claim 17.

19. A battery cell comprising:
an anode comprising an anode current collector and an anode active material disposed over the anode current collector; and
the cathode of claim 18.
